(19) United States
(12) Patent Application Publication
(10) Pub. No.: US 2020/0261987 A1
(43) Pub. Date: Aug. 20, 2020

(54) Tool Holder Having A Rigid Sleeve

(71) Applicant: X'POLE PRECISION TOOLS INC., Taoyuan City (TW)

(72) Inventor: Peter CHEN, Taoyuan City (TW)

(21) Appl. No.: 16/278,333

(22) Filed: Feb. 18, 2019

(51) Int. Cl. B23B 31/30; B23B 31/00

(52) U.S. Cl. CPC B23B 31/305; B23B 2231/04; B23B 31/006

(57) ABSTRACT

A tool holder used in a machine having a spindle is provided with a connector including a truncated conic part received in the spindle, and a projection extending out of the truncated conic part; a tool mounting member including an axial hole for fastening a tool and a portion of a chuck, and a receptacle for complimentarily receiving the projection; and at least one sleeve formed of a material having a high rigidity, each sleeve including a cavity at one end, the cavity being configured to complimentarily receive the projection, and a protrusion at the other end, the protrusion being configured to complimentarily attach to the receptacle. The connector, the at least one sleeve, and the tool mounting member are secured together.

### BACKGROUND OF THE INVENTION

### 1. Field of the Invention

The invention relates to relates to tool holders and more particularly to a tool holder having a rigid sleeve.

### 2. Description of Related Art

Conventional high precision machining including drilling, milling, boring, cutting and polishing often uses computer numerical control (CNC) machine as an auxiliary device in cooperation with tools such as drills, cutters, or the like. The tools are shaped as an elongated handle. A tool holder may secure the tool to the spindle of the CNC machine. The spindle rotates in high speed to rotate the tool fastened by the tool holder for machining a workpiece.

The tool holder may vibrate strongly in machining and it may interfere with the machining, resulting in a poor quality of the finished workpiece. Further, components may collide one another resulting in undesired vibration which may interfere with the high frequency vibration. An in turn, it may adversely affect precision of the workpiece, and damage both the machine and the tool holder.

In a cutting process, any vibration between the tool holder and the workpiece may undesirably affect cutting and unsmooth surface and unacceptable quality of the workpiece. To the worse, the vibration may damage the tool holder and/or the tool. It is found that the longer of the tool holder the more serious of the vibration. Elongated tool holders are disclosed by U.S. Pat. Nos. 1,502,528, 2,716,030 and 8,821,084. For high length to diameter ratio, the precision of the workpiece may be very low or even be impossible of being machined due to rigidity of the material of the tool holder. These are problems encountered by the conventional machines. It may cause strong interference to undesirably vibrate the tool holder. The cutting effect is adversely affected. Also, smoothness and quality of the workpiece are low. To the worse, the machines are damaged.

Thus, the need for improvement still exists.

### SUMMARY OF THE INVENTION

It is therefore one object of the invention to provide a tool holder having at least one rigid sleeve so that the rigidity of the tool holder is improved, vibration between the tool holder and the tool held by the tool holder is decreased to a minimum, and both surface smoothness and precision of the finished workpiece are improved.

It is another object of the invention to provide a tool holder having a rigid sleeve wherein the length of the tool holder can be changed by providing at least one sleeve interconnecting a connector and a tool mounting member.

For achieving above an other objects of the invention, there is provided a tool holder used in a machine having a spindle, comprising a connector including a truncated conic part received in the spindle, and a projection extending out of the truncated conic part; a tool mounting member including an axial hole for fastening a tool and a portion of a chuck, and a receptacle for complimentarily receiving the projection; and at least one sleeve formed of a material having a high rigidity, each of the least one sleeve including a cavity at one end, the cavity being configured to complimentarily receive the projection, and a protrusion at the other end, the protrusion being configured to complimentarily attach to the receptacle; wherein the connector, the at least one sleeve, and the tool mounting member are secured together.

Preferably, there is further provided at least one sleeve member disposed between the connector and the at least one sleeve.

Preferably, each of the at least one sleeve member includes a recess at one end, the recess being configured to complimentarily receive the projection, and a protuberance at the other end, the protuberance being configured to complimentarily attach to the receptacle; and wherein the connector, the at least one sleeve member, the at least one sleeve, and the tool mounting member are secured together.

Preferably, the tool mounting member is formed of a material having a high rigidity.

Preferably, the connector further comprises an annular flange at a joining portion of the truncated conic part and the projection, and a V-shaped, annular groove on the annular flange.

### BRIEF DESCRIPTION OF THE DRAWINGS

The invention, as well as its many advantages, may be further understood by the following detailed description and drawings in which:

FIG. 1 is a longitudinal sectional view of a tool holder having a rigid sleeve according to a first preferred embodiment of the invention; and

FIG. 2 is a longitudinal sectional view of a tool holder having a rigid sleeve according to a second preferred embodiment of the invention.

### DETAILED DESCRIPTION OF THE INVENTION

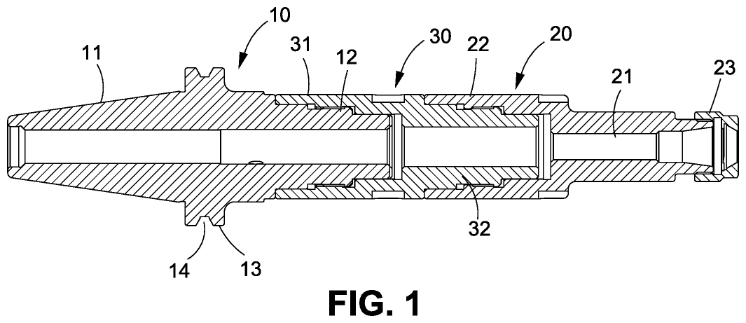

Referring to FIG. 1, a tool holder having a rigid sleeve according to a first preferred embodiment of the invention is used in a machine having a spindle (not shown). The tool holder comprises a connector 10 including a truncated conic part 11 received in the spindle, a projection 12 extending out of the truncated conic part 11, an annular flange 13 at a joining portion of the truncated conic part 11 and the projection 12, and a V-shaped, annular groove 14 on the flange 13. Thus, the tool holder may be used in an automatic cutter change system of the machine.

The tool holder further comprises a tool mounting member 20 which is substantially cylindrical. The tool mounting member 20 is formed of a material having a high rigidity, for example, tungsten carbide and including an axial hole 21 for fastening a tool and a portion of a chuck 23, and a receptacle 22 for complimentarily receiving the projection 12. It is noted that the fastening of the chuck 23 in the axial hole 21 is implemented by thread-type fastening. But it is one of a plurality of fastening methods. Those skilled in the art may be aware of other fastening methods.

The tool holder further comprises a sleeve 30 formed of a material having a high rigidity, for example, tungsten carbide. The sleeve 30 includes a cavity 31 at one end, the cavity 31 configured to complimentarily receive the projection 12, and a protrusion 32 at the other end, the protrusion 32 configured to complimentarily attach to the receptacle 22. As a result, the connector 10, the sleeve 30 and the tool mounting member 20 are secured together.

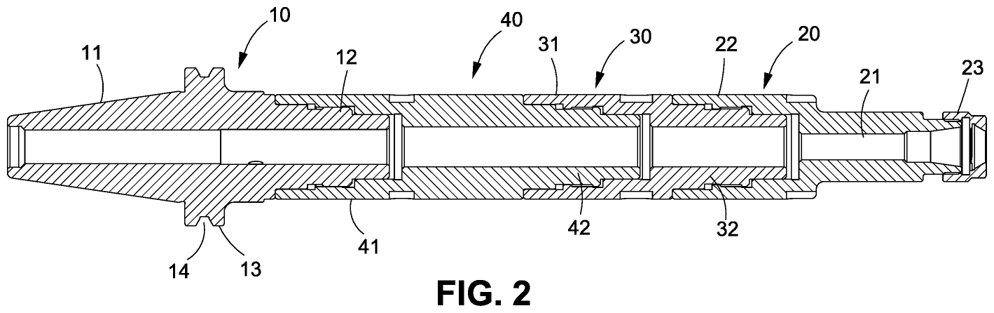

Referring to FIG. 2, a tool holder having a rigid sleeve according to a second preferred embodiment of the invention is shown. The characteristics of the second preferred embodiment are substantially the same as that of the first preferred embodiment except the following: at least one (e.g., one as shown) sleeve member 40 is disposed between the connector 10 and the sleeve 30. Each sleeve member 40 includes a recess 41 at one end, the recess 41 configured to complimentarily receive the projection 12, and a protuberance 42 at the other end, the protuberance 42 configured to complimentarily attach to the receptacle 22. As a result, the connector 10, the sleeve member 40, the sleeve 30 and the tool mounting member 20 are secured together. The number of each of the sleeve 30 and the sleeve member 40 can be increased or decreased depending applications. Thus, the length of the tool holder can be adjusted.

It is envisaged by the tool holder having a rigid sleeve of the invention that the tool holder having at least one rigid sleeve so that rigidity of the tool holder can be increased, undesired vibration of the tool holder and the tool held by the tool holder can be decreased to a minimum, and both surface smoothness and precision of the finished workpiece can be improved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A tool holder used in a machine having a spindle, comprising:
a connector including a truncated conic part received in the spindle, and a projection extending out of the truncated conic part;
a tool mounting member including an axial hole for fastening a tool and a portion of a chuck, and a receptacle for complimentarily receiving the projection; and
at least one sleeve formed of a material having a high rigidity, each of the least one sleeve including a cavity at one end, the cavity being configured to complimentarily receive the projection, and a protrusion at the other end, the protrusion being configured to complimentarily attach to the receptacle;
wherein the connector, the at least one sleeve, and the tool mounting member are secured together.

2. The tool holder of claim 1, further comprising at least one sleeve member disposed between the connector and the at least one sleeve.

3. The tool holder of claim 2, wherein each of the at least one sleeve member includes a recess at one end, the recess being configured to complimentarily receive the projection, and a protuberance at the other end, the protuberance being configured to complimentarily attach to the receptacle; and wherein the connector, the at least one sleeve member, the at least one sleeve, and the tool mounting member are secured together.

4. The tool holder of claim 1, wherein the tool mounting member is formed of a material having a high rigidity.

5. The tool holder of claim 1, wherein the connector further comprises an annular flange at a joining portion of the truncated conic part and the projection, and a V-shaped, annular groove on the annular flange.
